(19) United States
(12) Patent Application Publication
(10) Pub. No.: US 2006/0255212 A1
(43) Pub. Date: Nov. 16, 2006

(54) Positioning system

(76) Inventor: Oliver Hildebrandt, Fellbach (DE)

Correspondence Address: Mr. Robin W. Asher;Clark Hill PLC, Suite 3500, 500 Woodward Avenue, Detroit, MI, 48226-3435, US

(21) Appl. No.: 11/396,855

(22) Filed: Apr. 3, 2006

(30) Foreign Application Priority Data
Apr. 1, 2005 (DE) 102005016436.6

(51) Int. Cl. A62C 13/76; B05B 15/06

(52) U.S. Cl. 248/75; 239/273; 239/282

(57) ABSTRACT

A system for positioning a first element (3) at an opening (2) of a second element (1) comprises fixing means (7) for fixing the first element (3) to the second element (1). The system further comprises a guide element (4) which is attached by frangible points (5) to the first element (3) until the positioning is completed, said guide element being adapted to the be inserted in interlocking engagement in the opening (2) of the second element (1), thereby attaining a predetermined alignment of the first element (3) relative to the second element (1). Furthermore, the present invention relates to a corresponding method of positioning a first element at an opening of a second element and the use of a positioning system for positioning a spray nozzle holder on a bore provided in a motor vehicle bumper.

### RELATED APPLICATION

This application claims all the benefits of and priority to German patent application no. 2005 016 436.6, filed on Apr. 1, 2005.

### BACKGROUND OF THE INVENTION

1. Field of the Invention

The present invention relates to a system for positioning a first element at an opening of a second element, more particularly, for positioning a spray nozzle holder at an opening or bore in a bumper of a motor vehicle. Furthermore, the present invention relates to a method of positioning a first element at an opening of a second element and the use of a positioning system of this kind for positioning a spray nozzle holder at a bore in a car bumper.

2. Description of the Related Art

In the automotive industry, numerous holders or holding devices are used for all kinds of applications, these holders being mounted in or on the corresponding vehicle bodywork. There are applications in which holders are provided which are invisible or concealed from the outside and the corresponding functional units which are held by the holders are applied to the respective parts of the vehicle through bores provided expressly for this purpose. Thus, for example, spray nozzles for head lamps are secured through holders underneath openings in a bumper or bumper bar provided expressly for the spray nozzles.

It is known to fix spray nozzles of this kind through a holder which is adhered to an inner surface of the bumper. For this purpose, the holding device has a plate provided with an adhesive or an adhesive film which is bonded to an inner surface of the bumper. Aligning the holding device as accurately as possible with respect to the opening or bore provided in the bumper or bumper bar for the spray nozzle demands considerable care and generally requires the use of a so-called centering rod or similar aid. Misalignment results in a non-centered bonding of the holding device to the bumper, which, on one hand, results in an optically unsatisfactory design and, on the other hand, leads to defective positioning of the spray nozzle relative to the headlamp which is to be cleaned. The kind of spray nozzle which may be used is, for example, a spray nozzle that can be telescopically extended for use. In this case, it is very important to get the precise alignment of the holder with the corresponding bore in the vehicle body as otherwise unobstructed extension of the spray nozzle cannot be guaranteed. Incorrect adhesion of the holding device to the bumper may also result in the whole bumper having to be scrapped if the adhesive has already dried too hard, with considerable cost implications.

The same applies to the mounting or positioning of spray nozzles at other points on a vehicle, such as, for example, spray nozzles for cleaning the windows. In order to be able to guarantee sufficiently high quality both in the operation of the spray nozzles and in the design as a whole, considerable time is needed to mount the spray nozzles or their holders in precise alignment with correspondingly provided bores or openings in the bodywork.

### SUMMARY OF THE INVENTION

Against the background of the known procedure, it is desirable to be able to ensure easier, more precise and operationally reliable positioning of a holder relative to a bore provided for it. In the case of a spray nozzle, every effort should be made to ensure that the same gaps are always achieved between a spray nozzle head and a bore suitable for engagement of the spray nozzle head, e.g., in a bumper.

The present invention proposes a system for positioning a first element at an opening in a second element, the first element-comprising fixing means for fixing the first element to the second element. The system further comprises a guide element which is connected via predetermined breaking points, i.e., frangible points to the first element until the positioning of the first element at the opening of the second element is concluded. The guide element provided according to the invention is adapted to be inserted in interlocking engagement in the opening in the second element, thereby achieving a predetermined alignment of the first element relative to the second element.

In one embodiment of the system according to the invention, the first element is a holder for a spray nozzle with means for positioning the spray nozzle on the holder and with a recess which is centrally covered by the guide element and which corresponds to the opening in the second element. In the case of a rod-shaped spray nozzle, the holder provided therefore may be a hollow cylinder which is open at least at one end. The open end of the hollow cylinder, when the holder is properly positioned, is arranged adjacent to the opening of the second element such that a spray nozzle received through the holder is able to engage through the open end of the hollow cylinder into the opening in the second element. The hollow cylinder may furthermore be provided on its inside with suitable ribs which fix a spray nozzle which is to be held inside the holder and thus ensure a stable grip. The spray nozzle head is able to project or be extended in a manner suitable for use through the at least one open end. The at least one open end is appropriately arranged on a bore provided for this purpose in the second element, such as a bumper, for example, so that the spray nozzle head can be disposed through the open end of the hollow cylinder and through the bore in the bumper in a suitable position relative to the head lamp.

According to the invention, it is envisaged that the recess or opening in the holder corresponding to the opening in the second element is centrally covered by the guide element until the positioning of the holder is concluded. The guide element is connected to the holder of the spray nozzle via predetermined breaking points, i.e., frangible points.

In another embodiment of the system according to the invention, the fixing means of the first element, i.e., in the case of a spray nozzle, the spray nozzle holder, are formed by a plate provided with an adhesive film. The plate provided with an adhesive film is adapted to be adhered to the inside of the second element, for example, the bumper.

It is also possible for the guide element to be connected to the first element, e.g., the spray nozzle holder, via a plurality of ribs provided with small notches, which form the frangible points.

In another embodiment of the system according to the invention, the guide element is formed by a conical centering dome. The conical shape of the centering dome ensures that during the positioning of the first element, such as the spray nozzle holder, for example, relative to the opening in the second element, such as a bore in a bumper, for example, the introduction of the centering dome as a guide element into the opening in the second element is made much simpler. Because of the conical shape, there is virtually automatic engagement in the opening in the second element as the rounding of the guide element makes engagement considerably easier. Other embodiments of the guide element are possible. Shapes which facilitate virtually automatic engagement of the guide element as it approaches the opening in the second element are preferred.

In another embodiment of the positioning system according to the invention, it is possible for the guide element to be injection molded onto the first element. It is possible for the guide element and the first element to be injection molded in one piece from plastics. The plastics used may be, in addition to polypropylene, other plastics such as PA 6.6. In addition, the plastics may be reinforced with fiberglass.

The present invention further relates to a method of positioning a first element at an opening in a second element. In the method proposed according to the invention, a guide element is provided which is attached to the first element via frangible points and is adapted to be inserted with interlocking engagement in the opening in the second element. Thus, a predetermined alignment of the first element relative to the second element is achievable. The guide element is also brought into interlocking engagement with the opening in the second element, so that the first element is arranged in the predetermined alignment relative to the second element. Then, the first element is attached to the second element by fixing means and the guide element is detached from the first element at the frangible points by the application of a directed force.

The first element may, for example, be a spray nozzle holder, while the second element may be a bumper provided with a bore on which a spray nozzle for a headlamp, for example, is to be arranged. The mounting of the spray nozzle in the bore in the bumper provided for the spray nozzle has to be done very accurately so that both the operation of the spray nozzle and the design meet very high quality standards.

The spray nozzle may furthermore be a telescopically extending spray nozzle, i.e., a spray nozzle which when activated emerges telescopically from the bore in order to spray the respective headlamp with water or spraying fluid. It is important that the holder provided for the spray nozzle is properly inserted or arranged. Accordingly, the holder for the spray nozzle is positioned correspondingly well relative to the bore in the bumper into which the spray nozzle is intended to engage. The holder must be positioned so that a spray nozzle received through the holder can engage centrally in the bore in the bumper provided for it. To achieve this, it is envisaged in the method according to the invention that the holder be provided with a guide element which is adapted to be inserted in interlocking engagement in the opening or bore in the second element or bumper.

The guide element may, for example, be in the form of a conical centering dome. The central axis of the centering dome, after insertion in the bore in the bumper, coincides with the central axis of the bore in the bumper and the central axis of a spray nozzle duly inserted in the holder after the positioning process has ended. The conical shape of the centering dome assists the positioning of the holder relative to the bore in the bumper, as the centering dome engages virtually automatically in the opening in the bumper by virtue of its rounded shape as it approaches the bore in the bumper.

According to the invention, once the guide element has engaged in the bore in the bumper, the first element or the holder is attached to the second element or the bumper by means of the fixing means provided for this purpose. The fixing means provided may be, for example, an adhesive or adhesive film provided on an end plate of the holder. Once the first element or the holder has been attached to the second element or the bumper, the guide element in the form of a conical centering dome, for example, is detached from the first element, such as the holder, for example, at the frangible points expressly provided for this purpose by the application of a directed force. Only after the guide element has been detached from the first element is the spray nozzle with its corresponding spray nozzle head inserted in the holder.

In one embodiment of the method according to the invention, the guide element provided and the first element are injection molded in one piece from a plastics material.

The guide element may thereby be connected to the first element, such as the holder, for example, via a plurality of ribs with small notches. The ribs with small notches thus constitute the frangible points.

In the case of a holder for a spray nozzle, it may be that the holder is cylindrical and is provided on the inside with ribs that secure a spray nozzle.

The provision of a guide element ensures easy, exact and operationally reliable positioning of the holder relative to the bore in the corresponding bumper. The same pattern of joining a spray nozzle head and a corresponding bore in the bumper is obtained every time. Thus, a high quality assembly can be achieved both in terms of the functioning of the spray nozzle and also in relation to the design.

The guide element may be attached to the first element, such as the holder, for example, in such a way that when the guide element engages in the opening in the second element, such as the bore in the bumper, for example, the holder is centrally aligned relative to the bore. This ensures that when a spray nozzle is inserted in the holder, the spray nozzle together with the spray nozzle head is able to engage in a precisely centered manner in the bore in the bumper. When exact positioning is obtained, it is also possible to ensure that the holder, which is generally made of a plastics of a different color from the bumper, cannot be detected from the outside. This means that the arrangement of the holder is totally concealed. According to the invention, once the positioning of the holder is complete, the guide element is detached from the holder at the frangible points expressly provided for this purpose by a suitable application of force. The frangible points are such that only a slight force is needed to detach the guide element from the holder. At the same time, however, the frangible points have to withstand lesser shear forces which may occur, for example, when the holder is moved along the bumper in the course of the positioning, before the guide element can be engaged in the bore provided. The frangible points may, for example, be in the form of a kind of film hinge, respectively.

The guide element may be cylindrical in construction and may be shaped like a dome or cupola at its free end which is intended to engage in the opening in the second element. In addition, it is also possible to provide a kind of pyramid or cone shape instead of a cupola shape. Any shape which will easily engage in an interlocking manner in the bore can be used.

The fixing means for fixing the holder on the bumper may be provided in the form of a plate which comprises an adhesive film on its side facing the underside of the bumper, in order to adhesively bond it therewith to the underside of the bumper. Moreover, the plate may be flexible so that it automatically fits the shape of the underside of the bumper during the adhesion process and thus provides a uniform adhesive layer. The flexibility of the plate may be achieved by making the plate from a plastics material the thickness of which varies uniformly over the entire area of the plate, thus ensuring that the thinner areas provide the flexibility.

### BRIEF DESCRIPTION OF THE DRAWINGS

Further features and possible embodiments of the invention are described with reference to the appended drawing and the associated description.

It will be understood that the features mentioned above and those to be described hereinafter may be used not only in the particular combination specified but in other combinations or on their own without departing from the scope of the present invention. The invention is schematically illustrated by means of an exemplary embodiment in the drawing and is hereinafter described in detail with reference to the following drawing, wherein:

FIG. 1 shows a preferred embodiment of a system according to the invention for positioning a spray nozzle holder on a bore in a car bumper.

### DETAILED DESCRIPTION OF THE PREFERRED EMBODIMENT

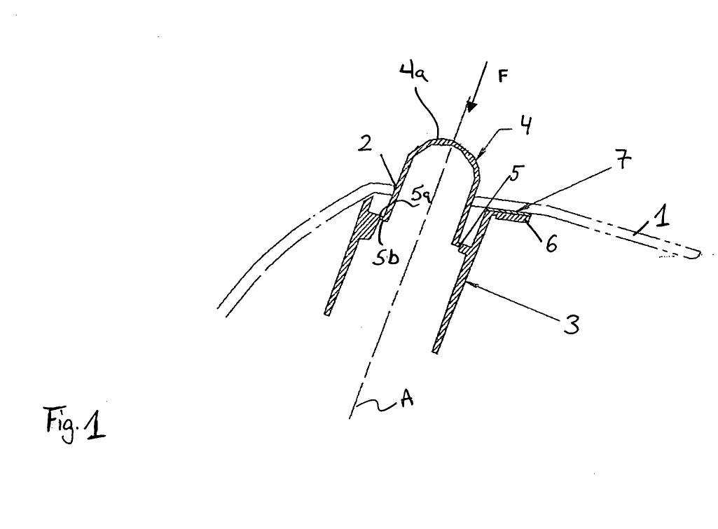

FIG. 1 shows a bumper 1 of a motor vehicle or car. The bumper 1 includes a bore 2 through which a spray nozzle or a spray nozzle head (not shown here) can project in order to spray a headlamp (not shown) of the car with a corresponding cleaning agent. FIG. 1 also shows a holder 3 which is constructed so as to be capable of accommodating a corresponding spray nozzle. The holder 3 may, for example, have suitable ribs on the inside, by means of which a spray nozzle which is to be held can be secured. The holder 3 may be made of a plastics material such as, for example, polypropylene or PA 6.6. The plastics material may also be reinforced with fiberglass.

In addition, the holder 3 may be injection molded. The holder 3 is connected to a guide element 4. The connection between the guide element 4 and the holder 3 is formed by frangible points 5. The frangible points 5 shown here may, for example, correspond to ribs 5a provided with notches 5b extending transversely between the holder 3 and the guide element 4. The guide element 4 may be injection molded onto the holder 3. It is possible for the holder 3 and the guide element 4 to be injection molded in one piece from plastics. The plastics used may be, as mentioned previously, polypropylene or a similar plastics, such as PA 6.6. The guide element 4 shown here includes a conical centering dome 4a.

Moreover, the holder 3 has an end plate 6. The end plate 6 supports an adhesive film 7. Using the adhesive film 7, the end plate 6 and hence the holder 3 may be secured to an inside of the bumper 1.

Before the holder 3 is secured to the bumper 1, the holder 3 must be accurately positioned relative to the bore 2 provided in the bumper 1. The holder 3 in the form shown here corresponds to a cylindrical hollow body which serves to receive the spray nozzle mentioned previously. The cylindrical hollow body must be aligned during the positioning of the holder 3 relative to the bore 2 provided in the bumper 1 such that the central axis A of the hollow body, and hence the central axis of a spray nozzle properly inserted after the positioning process, and the central axis of the bore 2 coincide or are identical. This is achieved by the fact that the guide element 4 constructed as a conical centering dome 4a also has a central axis A which coincides with the central axis A of the cylindrical hollow body and moreover is able to engage in respect of its dimensions accurately, i.e., interlockingly, in the bore 2 in the bumper 1, when the holder 3 is moved along the underside of the bumper 1 in the direction of the bore 2. As soon as the guide element 4 has engaged with the bore 2 in the bumper 1, the above-mentioned central axis A of the cylindrical hollow body and the bore 2 coincide. The holder 3 can then be adhesively bonded to the bumper 1 and the guide element 4 can be broken away at the frangible points 5 by the application of a directed force F, as indicated by the arrow. Then, a suitable spray nozzle can be inserted into the holder 3, which can then be extended outwards in a precisely centered manner through the bore 2.

What is claimed:

1. A system for positioning a first element (3) at an opening (2) in a second element (1), the first element (3) having fixing means (7) for fixing the first element (3) to the second element (1), and the system having a guide element (4) connected via frangible points (5) to the first element (3), said guide element being adapted to be inserted with interlocking engagement in the opening (2) of the second element (1), thereby aligning the first element (3) relative to the second element (1).

2. A system according to claim 1, wherein the first element (3) is a holder for a spray nozzle with a recess centrally covered by the guide element (4) and corresponding to the opening (2) in the second element (1) through which recess a spray nozzle held in the holder can engage in the opening (2) of the second element (1).

3. A system according to claim 1, wherein the fixing means (7) of the first element (3) is formed by a plate (6) provided with an adhesive film (7).

4. A system according to claim 3, wherein the guide element (4) is connected to the first element (3) via a plurality of ribs (5a) comprising notches (5b) defining said frangible points (5).

5. A system according to claim 4, wherein the guide element (4) is formed by a conical centering dome (4a).

6. A system according to claim 5, wherein the guide element (4) is injection molded onto the first element (3).

7. A method of positioning a first element on an opening in a second element, wherein
a guide element (4) connected to the first element (3) via frangible points (5) and adapted to be insertable with interlocking engagement in the opening (2) of the second element (1) is provided, by means of which a predetermined alignment of the first element (3) relative to the second element (1) can be achieved;
the guide element (4) is brought into engagement with the opening (2) in the second element (1), so that the first element (3) is arranged in the predetermined alignment relative to the second element (1);
the first element (3) is fixed to the second element (1) by fixing means (7); and
the guide element (4) is detached from the first element (3) at the frangible points (5) by means of a directed force F.

8. A method according to claim 7, wherein the guide element (4) and the first element (3) are injection molded in one piece from a plastics material.

9. A method according to claim 8, wherein the guide element is connected to the first element (3) via a plurality of ribs (5a) having notches (5b) defining the frangible points (5).

10. A method according to claim 9, wherein the guide element (4) is formed by a conical centering dome (4a).

11. A method according to claim 10, wherein a holder for a spray nozzle is used as the first element (3), the holder being provided with means for positioning the spray nozzle on the holder and with a recess centrally covered by the guide element (4) and corresponding to the opening (2) in the second element (1), through which recess a spray nozzle held in the holder after the positioning has ended is able to engage in the opening (2) in the second element (1).

12. A method according to claim 11, wherein the first element (3) is attached to the second element (1) by ad adhesive bonding process.
